(19) United States
(12) Patent Application Publication
(10) Pub. No.: US 2006/0246799 A1
(43) Pub. Date: Nov. 2, 2006

(54) Sound attenuating/absorbing laminates and methods of making same

(76) Inventors: Anthony Messina, Royal Oak, MI (US); Surendra Khambete, West Bloomfield, MI (US); Girma Gebreselassie, Southfield, MI (US)

Correspondence Address: MYERS BIGEL SIBLEY & SAJOVEC, PO BOX 37428, RALEIGH, NC, 27627, US

(21) Appl. No.: 11/475,333

(22) Filed: Jun. 27, 2006

Related U.S. Application Data
(62) Division of application No. 09/990,115, filed on Nov. 21, 2001, now abandoned.

(51) Int. Cl. B32B 5/18; B32B 3/00; B32B 5/24

(52) U.S. Cl. 442/120; 442/370; 442/372; 156/78; 156/79; 264/46.5; 264/257

(57) ABSTRACT

Sound attenuating laminates for use within vehicles are provided that include a substrate and polyurethane attached to selected portions of the substrate. The polyurethane is non-porous and serves as a barrier to attenuate sound passing through the substrate. Additional non-porous polyurethane may be added to one or more selected portions of the polyurethane layer to enhance sound attenuation characteristics in the one or more selected portions. Sound attenuating laminates for use within vehicles are provided that include a substrate and breathable polyurethane attached to selected portions of the substrate. The polyurethane serves as an absorber of sound (e.g., sound generated within a vehicle compartment). Additional breathable polyurethane may be added to one or more selected portions of the polyurethane layer to enhance sound absorption characteristics in the one or more selected portions. Porous, breathable carpet assemblies for use in vehicles, are provided and include a substrate and a porous carpet layer with breathable, porous polyurethane sandwiched therebetween. Breathable polyurethane may be applied onto the substrate second surface in one or more areas to enhance sound absorption characteristics of the carpet assembly.

### FIELD OF THE INVENTION

The present invention relates generally to vehicles and, more particularly, to trim components utilized within vehicles.

### BACKGROUND OF THE INVENTION

It is generally considered desirable to reduce the level of noise within a vehicle passenger compartment. External noises, such as road noise, engine noise, vibrations, etc., as well as noises emanating from within passenger compartments, may be attenuated through the use of various acoustical materials. Accordingly, sound attenuating materials for vehicles, such as automobiles, are conventionally used in the dashboard, in conjunction with carpeting for floor panels, in the wheel wells, in the trunk compartment, under the hood, and as part of the headliner.

The attenuation of external noise is conventionally referred to as sound transmission loss (STL). The attenuation of internal noise is conventionally referred to as sound absorption. The acoustic impedance of a material is defined as material density times acoustic velocity, and is expressed in units of Rayls (Newton-seconds/meter³). Acoustic impedance defines how easy it is for air to move through a material. Thus, for fibrous materials, acoustic impedance depends upon the density of the fibrous material and fiber diameter. Generally, the heavier the blanket and the finer the fibers, the higher the acoustic impedance. Moreover, thicker layers typically have more acoustic impedance than thin layers. The ability of a material to attenuate noise is conventionally defined by the material's STL, acoustic impedance, and absorption characteristics.

Carpeting used to cover the floor areas of vehicles, such as automobiles, is conventionally molded into a non-planar three dimensional contoured configuration which conforms to the contours of the vehicle floor so as to fit properly. In order to make the carpeting moldable and shape-sustaining, it is conventionally provided with a backing of thermoplastic polymer composition. The thermoplastic polymer backing also serves as a barrier to improve the sound deadening properties of the carpet assembly.

Dash insulators are often mounted to a vehicle firewall which separates the passenger compartment from an engine compartment. Dash insulators are designed to reduce the transmission of noise and heat from the engine compartment into the passenger compartment. Conventional dash insulators consist of an acoustical absorber such as an open-cell polyurethane foam or a resinated fiber pad which faces the fire wall, and a barrier sheet such as a heavily filled thermoplastic material. Dash insulator barriers are conventionally produced in a compounding process followed by an extrusion or calendaring process or by an injection molding process to achieve a barrier sheet of desired thickness and width.

Conventional carpet systems and dash insulators typically include an ethylene-vinylacetate (EVA), polyethylene (PE), or polyvinylchloride (PVC) layer which serves as a barrier sheet. Unfortunately, there are several drawbacks associated with the use of EVA, PE, and PVC layers in these vehicle applications. For example, EVA, PE, and PVC are non-porous materials which can be relatively heavy when applied to carpeting, dash insulators, and other interior trim components. In addition, EVA, PE, and PVC are conventionally applied in layers have a non-varying thickness. As such, some material may be wasted in areas where sound transmission is not problematic, thereby increasing weight unnecessarily.

Various sound attenuating materials have been developed for use in reducing noise levels within passenger compartments of vehicles. For example, U.S. Pat. No. 4,851,283 to Holtrop et al., proposes a thermoformable laminate for use in headliners. The headliner comprises a non-woven fabric bonded to a foamed polymer sheet. The fabric is formed from a blend of low melting staple fibers and high melting staple fibers.

U.S. Pat. No. 5,298,694 to Thompson proposes a non-woven acoustical insulation web. The web comprises thermoplastic fibers, and particularly a blend of melt-blown microfibers and crimped bulking fibers.

U.S. Pat. No. 5,677,027 to Masuda et al., proposes a sound insulating structure comprising a covering layer, a panel, and a cushioning layer. The cushioning layer comprises a first fiber such as polyethylene terephthalate (PET) and a second fiber that is of a shell-core construction wherein the majority of the core is PET.

U.S. Pat. No. 5,817,408 to Orimo et al., proposes a sound insulating structure which includes low and high density thermoplastic fibers. PET is preferred as a thermoplastic synthetic fiber.

U.S. Pat. No. 4,529,639 to Peoples, Jr. et al. proposes a molded foam-backed carpet assembly which includes a carpet layer, a moldable thermoplastic polymer layer and one or more foam pads fusibly bonded to the thermoplastic layer and extending over less than the entire surface of the thermoplastic polymer layer to provide desired cushioning and sound and thermal insulation only in preselected areas of the carpet.

In general, the ability of conventional materials to attenuate sound increases as the amount of material increases. Unfortunately, increased materials often increases the weight of sound attenuating material, which may be undesirable. Accordingly, there is a continuing need for acoustical insulation materials for use within vehicles that exhibit superior sound attenuating properties, while also being lightweight and low in cost.

### SUMMARY OF THE INVENTION

In view of the above discussion, sound attenuating and/or absorption laminates for use within vehicles such as floor coverings and other interior trim components, and methods of producing same, are provided. According to embodiments of the present invention, a sound attenuating laminate configured to be attached to an article, such as a vehicle panel, includes a substrate having a shape of the article, and polyurethane attached to selected portions of the substrate. The polyurethane is non-porous and serves as a barrier to attenuate sound passing through the substrate. Additional non-porous polyurethane may be added to one or more selected portions of the polyurethane layer to enhance sound attenuation characteristics in the one or more selected portions. According to embodiments of the present invention, one or more of the substrate surfaces may have recessed portions formed therein, and additional non-porous polyurethane may be applied in the one or more recessed portions to further enhance sound attenuation characteristics. According to embodiments of the present invention, one or more secondary articles (e.g., plastic pass-throughs, etc.) may be molded-in with the substrate and additional non-porous polyurethane may be applied over the one or more molded-in articles to further enhance sound attenuation characteristics.

According to embodiments of the present invention, a sound absorption laminate configured to be attached to an article, such as a vehicle panel, includes a substrate having a shape of the article, and breathable polyurethane attached to selected portions of the substrate. The polyurethane serves as an absorber of sound (e.g., sound generated within a vehicle compartment). Additional breathable polyurethane may be added to one or more selected portions of the polyurethane layer to enhance sound absorption characteristics in the one or more selected portions. According to embodiments of the present invention, one or more of the substrate surfaces may have recessed portions formed therein, and additional breathable polyurethane may be applied in the one or more recessed portions to further enhance sound absorption characteristics.

According to embodiments of the present invention, a porous, breathable carpet assembly (or dash insulator) for use in vehicles, is provided and includes a substrate and a porous carpet layer secured to the substrate. The substrate has opposite first and second surfaces and the porous carpet layer is adhesively secured to the substrate via a breathable polyurethane layer. The substrate first surface is configured to be attached to a vehicle panel in contacting face-to-face relationship therewith. The substrate may be formed into the shape of a vehicle floor panel (or vehicle firewall) such that the substrate first surface attaches to the vehicle floor panel (or firewall) in contacting face-to-face relationship therewith.

Breathable polyurethane may be applied onto the substrate second surface in one or more areas to enhance sound absorption characteristics of the carpet assembly. Alternatively, or in addition to, non-porous polyurethane may be applied onto the substrate second surface in one or more areas to enhance sound attenuation characteristics of the carpet assembly (or dash insulator).

Sound attenuating and/or absorption laminates, sound absorbing carpet assemblies, and sound absorbing dash insulators, according to embodiments of the present invention, can provide desired sound deadening and absorption properties in selected vehicle locations, such as floor pans, door panels, firewalls, headliners, spare tire covers, etc. Moreover, sound attenuating and/or absorption laminates according to embodiments of the present invention may have reduced overall weight without sacrificing soundproofing properties.

### BRIEF DESCRIPTION OF THE DRAWINGS

The accompanying drawings, which form a part of the specification, illustrate key embodiments of the present invention. The drawings and description together serve to fully explain the invention.

FIG. 1 is cross-sectional view of a portion of a sound attenuating laminate according to embodiments of the present invention.

FIG. 2 is cross-sectional view of a portion of a sound attenuating laminate according to other embodiments of the present invention.

FIG. 3 is cross-sectional view of a portion of a sound attenuating laminate according to other embodiments of the present invention.

FIG. 4 is cross-sectional view of a portion of a sound attenuating laminate according to other embodiments of the present invention.

FIG. 5 is cross-sectional view of a portion of a sound attenuating laminate according to other embodiments of the present invention.

FIG. 6 is a flowchart of operations for producing sound attenuating laminates of FIGS. 1-4, according to embodiments of the present invention.

FIG. 7A is cross-sectional view of a portion of a sound absorption laminate according to embodiments of the present invention.

FIG. 7B is cross-sectional view of a portion of a sound absorption laminate according to other embodiments of the present invention.

FIG. 7C is cross-sectional view of a portion of a sound absorption laminate according to other embodiments of the present invention.

FIG. 8 is cross-sectional view of a portion of a sound absorbing laminate according to other embodiments of the present invention.

FIG. 9 is a flowchart of operations for producing sound attenuating laminates of FIGS. 7A-7C, according to embodiments of the present invention.

FIG. 10 is cross-sectional view of a portion of a porous, breathable carpet assembly according to embodiments of the present invention.

FIGS. 11-12 are perspective views of an exemplary carpet assembly for a vehicle according to embodiments of the present invention.

FIG. 13 is a perspective view of an exemplary dashboard insulator for a vehicle according to embodiments of the present invention.

FIG. 14 is a flowchart of operations for producing the carpet assembly of FIGS. 10-12, according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like when used herein are for the purpose of explanation only.

Embodiments of the present invention provide sound attenuating and/or absorbing laminates and carpet assemblies for use in various applications, particularly automotive applications. Exemplary automotive applications within which sound attenuating and/or absorbing laminates and carpet assemblies according to embodiments of the present invention may be utilized include, but are not limited to, floor coverings, door panels, dash insulators, trunk liners headliners, various interior trim components, etc.

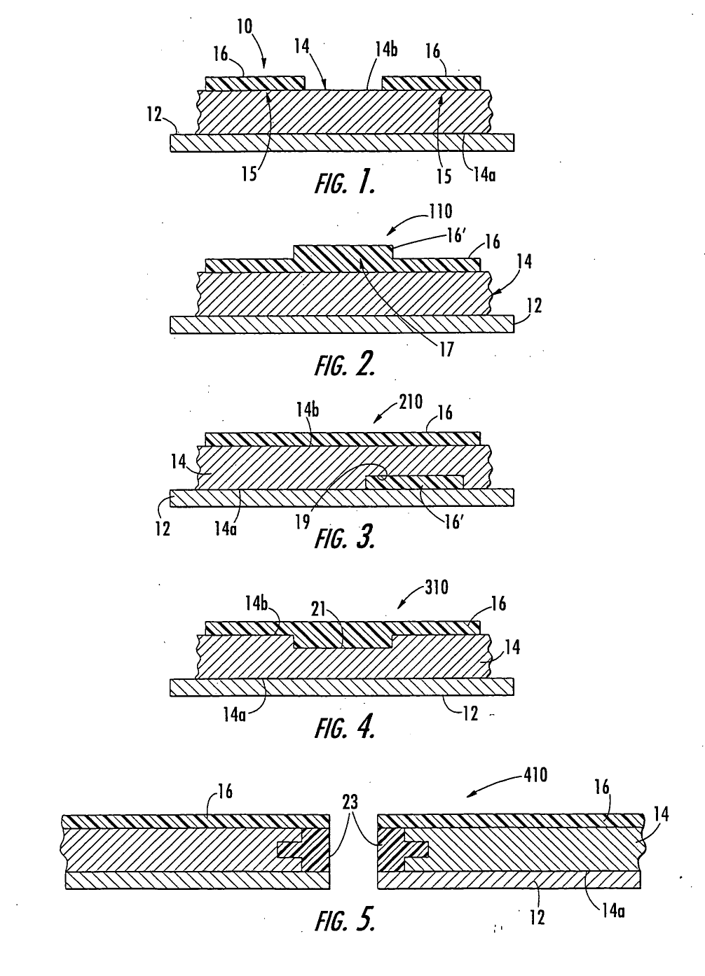

Referring to FIG. 1, a section view of a portion of a sound attenuating laminate 10 that is configured to attenuate noise according to embodiments of the present invention, is illustrated. The sound attenuating laminate 10 includes a substrate 14 having opposite first and second surfaces 14a, 14b. The first surface 14a is attached to an article 12, such as a vehicle panel, in contacting face-to-face relationship therewith. A polyurethane barrier layer 16 is applied to selected portions 15 of the substrate second surface 14b, as illustrated. The polyurethane barrier layer 16 may also be applied to the entire second surface 14b of the substrate. The polyurethane barrier layer 16 is non-porous and is configured to attenuate sound passing through the article (e.g., vehicle panel) and through the substrate 14.

The polyurethane barrier layer 16 has a density of about 1.0 to 3.0 pcf and a thickness of about 15 to 30 mm. The polyurethane barrier layer 16 comprises an isocyanate, a polyol and various additives such as crosslinking agents, catalysts, blowing agents and the like, the selection of which will be within the skill of one in the art. For example, the isocyanate component of the polyurethane includes one or more compounds selected from the group-consisting of diphenylmethane-4,4′-diisocyanate, diphenyldimethylmethane-4,4′-diisocyanate, phenylene-1,4-diisocyanate, 2,2′,6,6′-tetramethyldiphenylmethane-4,4′-diisocyanate, diphenyl-4,4′diisocyanate, diphenylether-4,4′-diisocyanate or its alkyl-, alkoxy- or halogen-substituted derivatives, toluylene-2,4- and -2,6-diisocyanates or their commercially available mixture, 2,4-diisocypropylphenylene-1,3-diisocyanate, m-xylylenediisocyanate, and p-xylylenediisocyanate.

Further, in the practice of the present invention, any desired types of polyester polyols and polyether polyols may be used as a polyol component of the polyurethane prepolymer solution. Examples of the crosslinking agent usable in the present invention include trifunctional or more functional polyisocyanate or hydroxyl compounds, for example, one or more compounds selected from the group consisting of ethylene glycol, propylene glycol, butane-1,4-diol, hexane-2,5-diol, 2,2-dimethylpropane-1,3-diol, hexane-1,6-diol, 2-methylhexane-1,6-diol, 2,2-dimethylhexane-1,3-diol, p-bishydroxymethyl cyclohexane, 3-methylpentane-1,4-diol, 2,2-diethylpropane-1,3-diol and the like. As the catalyst, tertiary amines, organic tin compounds, organic lead compounds and the like may be used. As the solvent capable of dissolving polyols and isocyanates, methyl ethyl ketone, ethyl acetate, toluene, xylene, dimethylformamide, methyl isobutyl ketone, butyl acetate, acetone or the like may be used alone or in combination. The polyurethane barrier layer 16 can be in the form of a slab foam, cast foam or a thermoformable foam.

According to embodiments of the present invention, the polyurethane may include a filler, such as calcium carbonate, calcium hydroxide, aluminum trihydrate, talc, bentonite, barytes, silica, clay and mica.

An exemplary unfilled polyurethane barrier material that may be used in accordance with embodiments of the present invention is Bayer Elastomer (Bayer AG, Pittsburgh, Pa.). An exemplary filled polyurethane barrier material that may be used in accordance with embodiments of the present invention is Huntsman Rimline SH 80309 (Huntsman Corporation, Salt Lake City, Utah).

The substrate 14 may be formed from any type of material including, but not limited to foam (e.g., polyurethane foam, thermoplastic foam, etc.), massback, and other thermoformable fibrous materials including those derived from natural and synthetic fibers. Massback is a relatively dense material, normally impermeable to air and thermoformable. Massback can be formed from virtually any plastic or rubber material which contains a high-mass filler material. An exemplary massback includes ethylene-vinylacetate (EVA) copolymer, polyethylene, or polyvinyl-chloride (PVC), and a high-mass filler material, such as glass, calcium carbonate or barium sulfate, added to increase the mass. Other suitable materials for the substrate include thermoformable stiff thermoplastic materials such as polystyrene, polyphenyl sulfide and polycarbonate, fiber-reinforced thermoplastics and fiber-reinforced thermosets such as epoxies, phenolics and the like.

The substrate 14 may be formed into a three-dimensional shape of the article 12 such that the substrate first surface 14a attaches to the article 12 in contacting face-to-face relationship therewith. The substrate 14 can have form retention characteristics such that it maintains a form imposed upon it. Alternatively, the substrate 14 may have elastic memory such that it is unable to maintain an unassisted non-flat configuration. For substrate materials having elastic memory, the polyurethane barrier layer 16 also serves the function of a binder such that the substrate 14 can maintain a shape imposed upon it via molding and other operations.

The article 12 may be virtually any type of vehicle panel (e.g., floor panel, firewall, door panel, wheel well, trunk compartment panel, etc.). For example, a sound attenuating laminate 10 according to embodiments of the present invention may be utilized as a dash insulator when attached to a vehicle firewall, may be utilized as a floor covering when attached to vehicle floor panels, and may be utilized as virtually any type of vehicle interior trim component.

Vehicle panels to which sound attenuating laminates according to the present invention may be attached may have various shapes, configurations, and sizes, and may be formed of various materials including, but not limited to metals, polymers, and combinations thereof. For example, a vehicle panel may be sheet metal having a three-dimensional configuration. Alternatively, a vehicle panel may be a substantially flat piece of sheet metal.

Referring to FIG. 2, a sound attenuating laminate 110 according to other embodiments of the present invention is illustrated. The illustrated sound attenuating laminate 110 includes a substrate 14 having opposite first and second surfaces 14a, 14b. The first surface 14a is attached to an article 12, such as a vehicle panel, as illustrated. A polyurethane barrier layer 16 is applied to the substrate second surface 14b, and additional polyurethane 16′ is added to a selected portion 17 of the polyurethane layer 16. Both the polyurethane barrier layer 16 and the additional polyurethane 16′ are preferably non-porous polyurethane and are configured to attenuate sound passing through the article 12 and through the substrate 14. The additional polyurethane 16′ is added to a specific location determined to require additional sound attenuation.

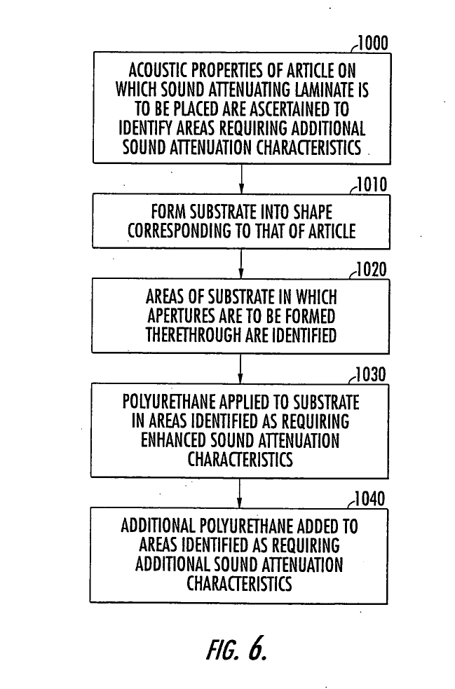

Referring to FIG. 3, a sound attenuating laminate 210 according to other embodiments of the present invention is illustrated. The illustrated sound attenuating laminate 210 includes a substrate 14 having opposite first and second surfaces 14a, 14b. The first surface 14a is attached to an article 12, such as a vehicle panel, as illustrated. A polyurethane barrier layer 16 is applied to the substrate second surface 14b, and additional polyurethane 16′ is disposed within a recess 19 formed within the substrate first surface 14a. Both the polyurethane barrier layer 16 and the additional polyurethane 16′ are non-porous polyurethane and are configured to attenuate sound passing through the article 12 and through the substrate 14. The additional polyurethane 16′ is added to the recess 19 to enhance sound attenuation characteristics of the sound attenuating laminate 210 in the area of the recess 19.

Referring to FIG. 4, a sound attenuating laminate 310 according to other embodiments of the present invention is illustrated. The illustrated sound attenuating laminate 310 includes a substrate 14 having opposite first and second surfaces 14a, 14b. A recess 21 is formed within the substrate second surface 14b. The first surface 14a is attached to an article 12, such as a vehicle panel, as illustrated. A polyurethane barrier layer 16 is applied to the substrate second surface 14b such that it also fills the recess 21 formed within the substrate second surface 14b. The polyurethane barrier layer 16 is a non-porous polyurethane and is configured to attenuate sound passing through the article 12 and through the substrate 14. The additional polyurethane 16 due to the recess 21 enhances sound attenuation characteristics of the sound attenuating laminate 310 in the area of the recess 21.

Sound attenuating laminates according to embodiments of the present invention illustrated in FIGS. 3-4 can have various numbers of recesses filled with non-porous polyurethane. Moreover, recesses filled with non-porous polyurethane may have various configurations and/or sizes.

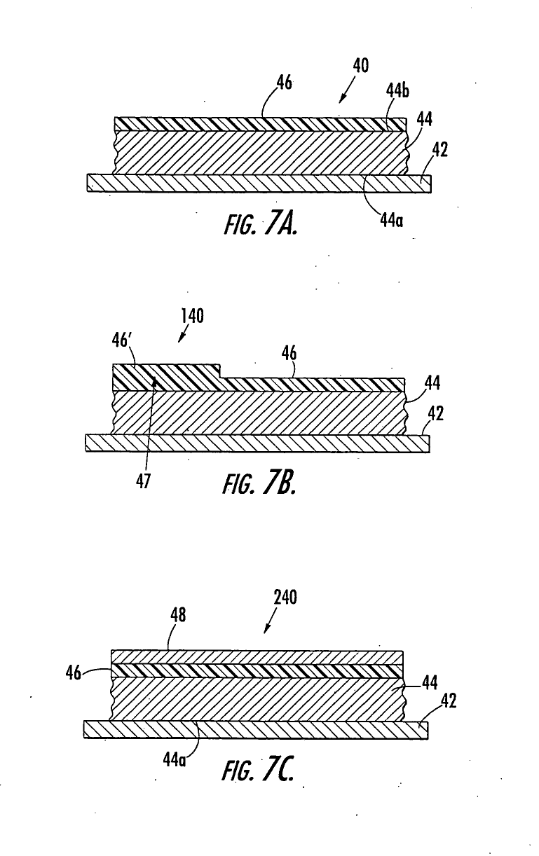

Referring to FIG. 5, a sound attenuating laminate 410 according to other embodiments of the present invention is illustrated. The illustrated sound attenuating laminate 410 includes a substrate 14 having opposite first and second surfaces 14a, 14b. A secondary article (e.g., a plastic pass-through) 23 is molded-in with the substrate 410. The first surface 14a is attached to an article 12, such as a vehicle panel, as illustrated. In the illustrated embodiment, the article 12 includes an aperture that is in communication with the aperture in the secondary article 23. Accordingly, an item, such as a cable, can be extended through the article aperture and through the sound attenuating laminate 410.

A polyurethane barrier layer 16 is applied to the substrate second surface 14b such that it overlies the molded-in secondary article 23 and surrounding area. The polyurethane barrier layer 16 is a non-porous polyurethane and is configured to attenuate sound passing through the article 12 and through the substrate 14. The additional polyurethane 16 enhances sound attenuation characteristics of the sound attenuating laminate 410 in the area of the molded-in secondary article 23. Secondary articles molded-in with substrates according to embodiments of the present invention can have various sizes, shapes, and configurations.

Referring now to FIG. 6, operations for forming sound attenuating laminates, according to embodiments of the present invention, are illustrated. The acoustic properties of an article, such as a vehicle panel, on which a sound attenuating laminate is to be placed are ascertained to identify areas requiring additional sound attenuation characteristics. (Block 1000). Acoustic properties of an article may be ascertained by identifying areas of an article through which sound within a predetermined frequency range passes at an intensity level that exceeds a threshold intensity level. Identifying areas of an article through which sound within a predetermined frequency range passes at an intensity level that exceeds a threshold intensity level may include generating a sound intensity map of the article. Sound intensity maps are well understood by those skilled in the art and need not be described further herein.

A substrate configured to be attached to the article in face-to-face contacting relationship is formed into a shape corresponding to that of the article (Block 1010). Areas of the substrate in which apertures are to be formed therethrough may be identified (Block 1020). Polyurethane is then applied (e.g., via spraying or other application techniques) to the substrate in areas identified as requiring enhanced sound attenuation characteristics (Block 1030). Areas of the substrate in which apertures are to be formed therethrough are preferably avoided during the application of the polyurethane barrier layer. Additional polyurethane may be added to areas identified as requiring additional sound attenuation characteristics (Block 1040). This may encompass applying additional polyurethane directly onto an existing polyurethane barrier layer and/or into one or more recessed portions formed within the substrate.

According to embodiments of the present invention, various ones of the operations illustrated in FIG. 6 may be performed out of the illustrated order. For example, polyurethane may be added to various portions of a substrate prior to forming (i.e., molding) operations. As another example, a substrate may be formed prior to the application of any polyurethane. As another example, polyurethane may be applied within a mold and additional polyurethane added in selected locations. A substrate may then be attached to the polyurethane and the composite article formed via the mold into a desired shape.

Furthermore, operations represented by Blocks 1030 and 1040 may be performed substantially simultaneously. For example, additional polyurethane can be added by adjusting processing speeds and/or by adjusting dispensing pressure, as would be understood by those skilled in the art.

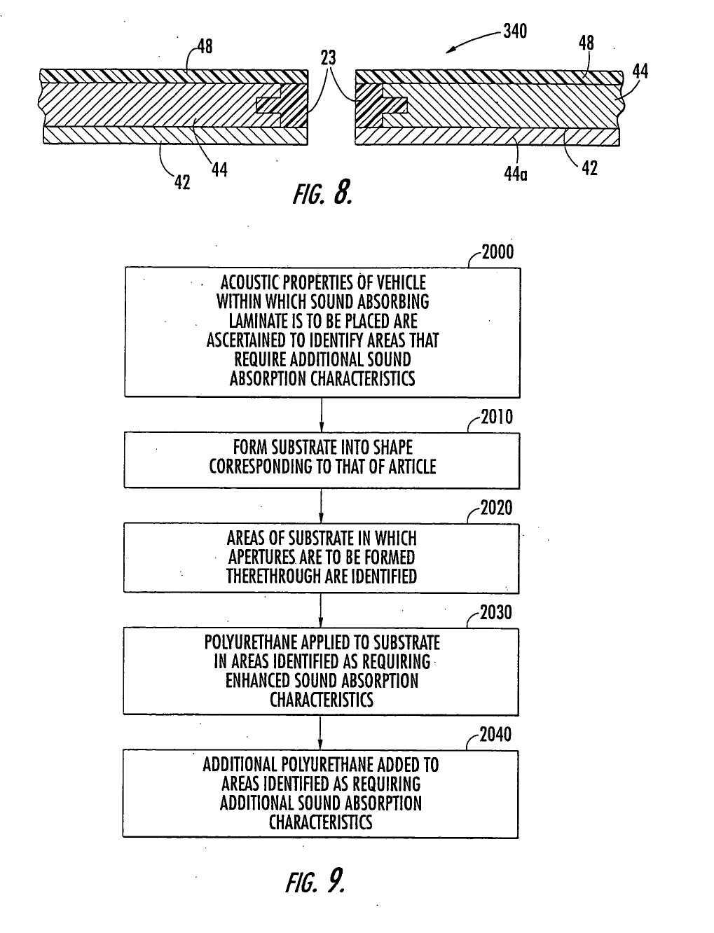

Referring now to FIGS. 7A-7C, section views of portions of sound absorbing laminates, according to embodiments of the present invention, are illustrated. In FIG. 7A, a sound absorbing laminate 40 includes a substrate 44 having opposite first and second surfaces 44a, 44b, and a layer of breathable polyurethane 46 disposed on the substrate second surface 44b. In the illustrated embodiment, the substrate first surface 44a is attached to an article 42 (e.g., a vehicle panel) in face-to-face relationship therewith. The breathable polyurethane layer 46 is configured to enhance sound absorption characteristics. For example, sound generated within a vehicle can be absorbed by the sound absorbing laminate 40 to provide a quieter environment within the vehicle.

The breathable polyurethane layer 46 has a density of about 1.0 to 3.0 pcf and a thickness of about 15 to 30 mm. The breathable polyurethane layer 46 comprises an isocyanate, a polyol and various additives such as crosslinking agents, catalysts, blowing agents and the like, the selection of which will be within the skill of one in the art. For example, the isocyanate component of the polyurethane includes one or more compounds selected from the group consisting of diphenylmethane-4,4′-diisocyanate, diphenyldimethylmethane-4,4′-diisocyanate, phenylene-1,4-diisocyanate, 2,2′,6,6′-tetramethyldiphenylmethane-4,4′-diisocyanate, diphenyl-4,4′diisocyanate, diphenylether-4,4′-diisocyanate or its alkyl-, alkoxy- or halogen-substituted derivatives, toluylene-2,4- and -2,6-diisocyanates or their commercially available mixture, 2,4-diisocypropylphenylene-1,3-diisocyanate, m-xylylenediisocyanate, and p-xylylenediisocyanate.

Further, in the practice of the present invention, any desired types of polyester polyols and polyether polyols may be used as a polyol component of the polyurethane prepolymer solution. Examples of the crosslinking agent usable in the present invention include trifunctional or more functional polyisocyanate or hydroxyl compounds, for example, one or more compounds selected from the group consisting of ethylene glycol, propylene glycol, butane-1,4-diol, hexane-2,5-diol, 2,2-dimethylpropane-1,3-diol, hexane-1,6-diol, 2-methylhexane-1,6-diol, 2,2-dimethylhexane-1,3-diol, p-bishydroxymethyl cyclohexane, 3-methylpentane-1,4-diol, 2,2-diethylpropane-1,3-diol and the like. As the catalyst, tertiary amines, organic tin compounds, organic lead compounds and the like may be used. As the solvent capable of dissolving polyols and isocyanates, methyl ethyl ketone, ethyl acetate, toluene, xylene, dimethylformamide, methyl isobutyl ketone, butyl acetate, acetone or the like may be used alone or in combination. The breathable polyurethane layer 46 can be in the form of a slab foam, cast foam or a thermoformable foam.

According to embodiments of the present invention, the breathable polyurethane layer 46 may include a filler such as calcium carbonate, calcium hydroxide, aluminum trihydrate, talc, bentonite, barytes, silica, clay and mica.

An exemplary breathable polyurethane material that may be used in accordance with embodiments of the present invention is Bayer Baypreg SA (Bayer AG, Pittsburgh, Pa.).

The substrate 44 may be formed from any type of material including, but not limited to foam (e.g., polyurethane foam, thermoplastic foam, etc.), massback, and other thermoformable fibrous materials including those derived from natural and synthetic fibers. Massback is a relatively dense material, normally impermeable to air and thermoformable. Massback can be formed from virtually any plastic or rubber material which contains a high-mass filler material. An exemplary massback includes ethylene-vinylacetate (EVA) copolymer, polyethylene, or polyvinyl-chloride (PVC), and a high-mass filler material, such as glass, calcium carbonate or barium sulfate, added to increase the mass. Other suitable materials for the substrate include thermoformable stiff thermoplastic materials such as polystyrene, polyphenyl sulfide and polycarbonate, fiber-reinforced thermoplastics and fiber-reinforced thermosets such as epoxies, phenolics and the like.

The substrate 44 may be formed into the shape of the article 42 such that the substrate first surface 44a attaches to the article 42 in contacting face-to-face relationship therewith. The substrate 44 can have form retention characteristics such that it maintains a form imposed upon it. Alternatively, the substrate 44 may have elastic memory such that it is unable to maintain an unassisted non-flat configuration. For substrate materials having elastic memory, the layer of breathable polyurethane 46 also serves the function of a binder such that the substrate 44 can maintain a shape imposed upon it via molding and other operations.

As illustrated in FIG. 7B, a sound absorbing laminate 140, according to embodiments of the present invention may include additional breathable polyurethane 46′ added to one or more selected portions 47 of the layer of breathable polyurethane 46. Both the layer of breathable polyurethane 46 and the additional polyurethane 46′ are configured to absorb sound. The additional polyurethane 46′ is added to a specific location determined to require additional sound absorption.

As illustrated in FIG. 7C, a sound absorbing laminate 240, according to embodiments of the present invention may include upholstery material 48 attached to the polyurethane layer 46 in face-to-face contacting relationship therewith.

According to embodiments of the present invention, the sound absorbing laminates of FIGS. 7A-7C may include one or more recessed portions formed within the substrate and additional breathable polyurethane is disposed therewithin as described above with respect to the sound attenuating laminate embodiments of FIGS. 1-4. In addition, according to embodiments of the present invention, the sound absorbing laminates of FIGS. 7A-7C may include one or more molded-in secondary articles within the substrate and additional breathable polyurethane may be disposed thereon and/or therearound as described above with respect to the sound attenuating laminate embodiments of FIGS. 1-4.

The article 42 to which sound absorbing laminates 40, 140, 240 according to the embodiments of FIGS. 7A-7C may be attached may be virtually any type of vehicle panel (e.g., floor panels, firewalls, door panels, wheel wells, trunk compartment panels, spare tire covers, headliners, etc.). For example, a sound absorbing laminate according to embodiments of the present invention may be utilized as a dash insulator when attached to a vehicle firewall, may be utilized as a floor covering when attached to vehicle floor panels, and may be utilized as virtually any type of vehicle interior trim component. Vehicle panels to which sound absorbing laminates illustrated in FIGS. 7A-7C may be attached may have various shapes, configurations, and sizes, and may be formed of various materials including, but not limited to metals, polymers, and combinations thereof. For example, a vehicle panel may be sheet metal having a three-dimensional configuration. Alternatively, a vehicle panel may be a substantially flat piece of sheet metal.

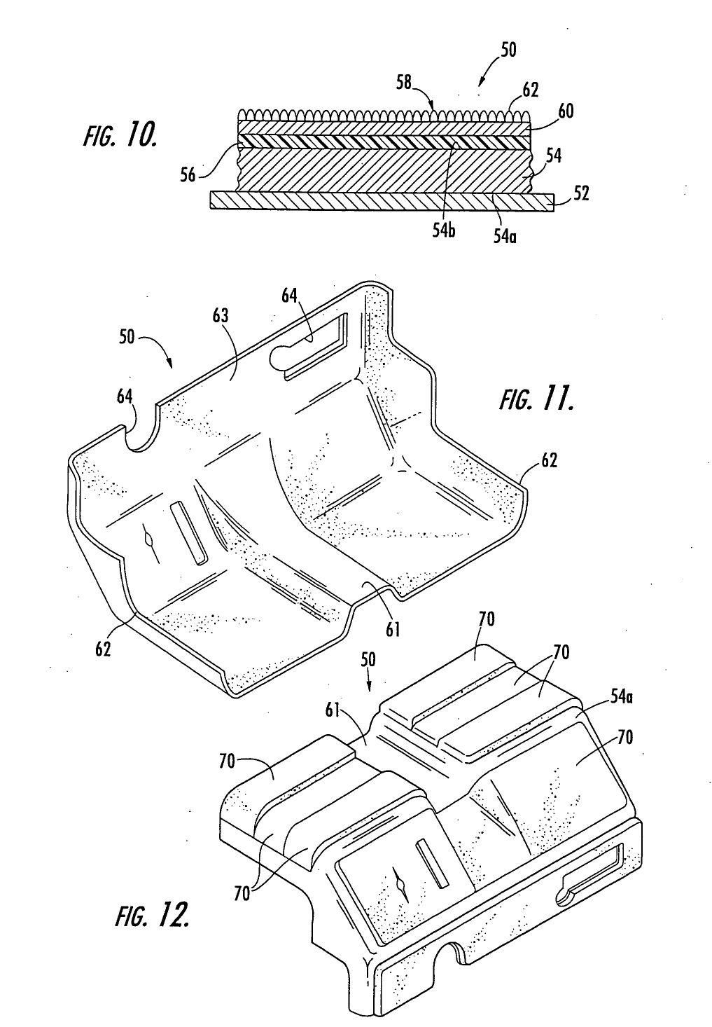

Referring to FIG. 8, a sound absorbing laminate 340 according to other embodiments of the present invention is illustrated. The illustrated sound absorbing laminate 340 includes a substrate 44 having opposite first and second surfaces 44a, 44b, and a layer of breathable polyurethane 46 disposed on the substrate second surface 44b. A secondary article (e.g., a plastic pass-through) 23 is molded-in with the substrate 340. In the illustrated embodiment, the article 42 includes an aperture that is in communication with the aperture in the secondary article 23. Accordingly, an item, such as a cable, can be extended through the article aperture and through the sound absorbing laminate 340. The breathable polyurethane layer 46 overlies the molded-in secondary article 23 and surrounding area and is configured to enhance sound absorption characteristics. For example, sound generated within a vehicle can be absorbed by the sound absorbing laminate 40 to provide a quieter environment within the vehicle. Secondary articles molded-in with substrates according to embodiments of the present invention can have various sizes, shapes, and configurations.

Referring now to FIG. 9, operations for forming sound absorbing laminates, according to embodiments of the present invention, are illustrated. The acoustic properties of a vehicle within which a sound absorbing laminate is to be placed are ascertained to identify areas that require additional sound absorption characteristics. (Block 2000).

A substrate configured to be attached to the article in face-to-face contacting relationship is formed into a shape corresponding to that of the article. (Block 2010). Areas of the substrate in which apertures are to be formed therethrough may be identified. (Block 2020). Breathable polyurethane is then applied (e.g., via spraying or other application techniques) to the substrate in areas identified as requiring enhanced sound absorption characteristics. (Block 2030). Areas of the substrate in which apertures are to be formed therethrough are preferably avoided during the application of the polyurethane barrier layer. Additional polyurethane may be added to areas identified as requiring additional sound absorption characteristics (Block 2040). This may encompass applying additional breathable polyurethane directly onto an existing layer of breathable polyurethane and/or into one or more recessed portions formed within the substrate.

According to embodiments of the present invention, various ones of the operations illustrated in FIG. 9 may be performed out of the illustrated order. For example, polyurethane may be added to various portions of a substrate prior to forming (i.e., molding) operations. As another example, a substrate may be formed prior to the application of any polyurethane. As another example, polyurethane may be applied within a mold and additional polyurethane added in selected locations. A substrate may then be attached to the polyurethane and the composite article formed via the mold into a desired shape.

Furthermore, operations represented by Blocks 2030 and 2040 may be performed substantially simultaneously. For example, additional polyurethane can be added by adjusting processing speeds and/or by adjusting dispensing pressure, as would be understood by those skilled in the art.

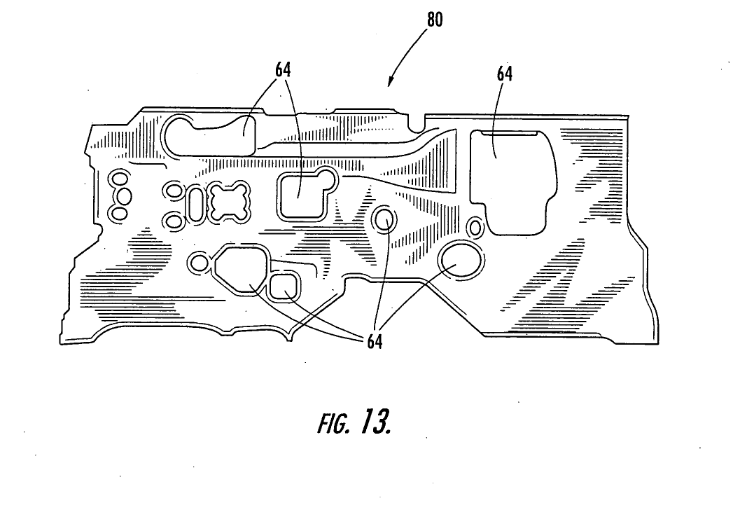

Referring now to FIG. 10, a section view of a portion of sound absorbing carpet assembly 50, according to embodiments of the present invention, are illustrated. The sound absorbing carpet assembly 50 includes a substrate 54 having opposite first and second surfaces 54a, 54b. A porous carpet layer 58 is adhesively secured to the substrate, either via a breathable polyurethane layer 56, or via another adhesive layer (not shown). The illustrated carpet layer 58 includes a backing 60 and carpet tufts 62 extending from the backing 60. The backing 60 is in contacting face-to-face relationship with the breathable polyurethane layer 56.

The substrate first surface 54a is configured to be attached to a vehicle floor panel 52 in contacting face-to-face relationship therewith. The substrate 54 may be formed from any type of material including, but not limited to foam (e.g., polyurethane foam, thermoplastic foam, etc.), massback, and other thermoformable fibrous materials including those derived from natural fibers, man-made fibers, and/or blends of natural fiber and man-made fibers.

The substrate 54 may be formed into the shape of a vehicle floor panel 52 such that the substrate first surface 54a attaches to the vehicle floor panel 52 in contacting face-to-face relationship therewith. The substrate 54 can have form retention characteristics such that it maintains a form imposed upon it. Alternatively, the substrate 54 may have elastic memory such that it is unable to maintain an unassisted non-flat configuration. For substrate materials having elastic memory, the breathable polyurethane layer 56 also serves the function of a binder such that the substrate 54 can maintain a shape imposed upon it via molding and other operations.

An exemplary porous, breathable carpet assembly 50 is illustrated in FIG. 11. The illustrated carpet assembly 50 has a non-planar three dimensional molded configuration adapted to fit the front seat compartment floor of a vehicle and includes a raised medial portion 61 adapted to conform to the transmission hump, generally vertically extending side portions 62 adapted to fit beneath each door opening, and a front portion 63 adapted to fit along the inclined floorboard and vertical firewall areas of a vehicle. Various openings or cut-outs are provided, as indicated at 64, to receive air conditioning equipment, the steering column, pedals and the like. It is to be understood that the particular three dimensional configuration illustrated is merely for purposes of illustration. Carpet assemblies according to embodiments of the present invention may have various configurations and shapes depending on the floor configuration of a vehicle.

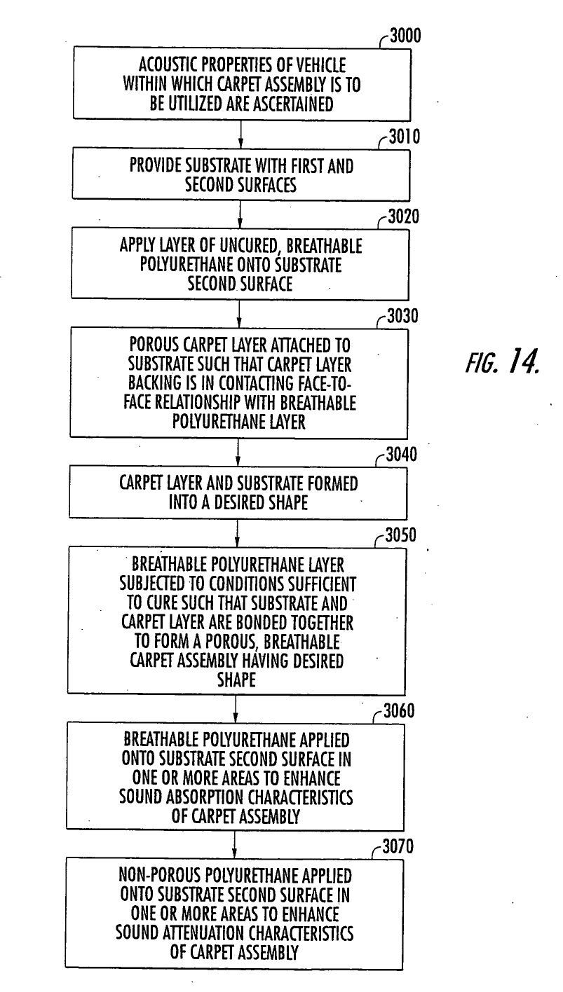

Referring to FIG. 12, additional polyurethane 70 is added to one or more selected portions of the substrate first surface 54a of the carpet assembly 50. The additional polyurethane 70 may be a breathable polyurethane such that sound absorption characteristics of the carpet assembly 50 are enhanced. Alternatively, The additional polyurethane 70 may be a non-porous polyurethane such that sound attenuation characteristics of the carpet assembly 50 are enhanced. Moreover, there may be a combination of breathable polyurethane and non-porous polyurethane such that both sound absorption and sound attenuation characteristics of the carpet assembly 50 are enhanced.

An exemplary porous, breathable dashboard insulator 80 is illustrated in FIG. 13. The illustrated dashboard insulator 80 has a non-planar three dimensional molded configuration adapted to fit the firewall of a vehicle. Various openings or cut-outs are provided, as indicated at 64, to receive air conditioning equipment, the steering column, pedals and the like. It is to be understood that the particular three dimensional configuration illustrated is merely for purposes of illustration. Dashboard insulators according to embodiments of the present invention may have various configurations and shapes depending on the firewall configuration of a vehicle. Additional polyurethane may be added to one or more selected portions of the dashboard insulator as described above. The additional polyurethane may be a breathable polyurethane such that sound absorption characteristics of the dashboard insulator 80 are enhanced. Alternatively, the additional polyurethane may be a non-porous polyurethane such that sound attenuation characteristics of the dashboard insulator 80 are enhanced. Moreover, there may be a combination of breathable polyurethane and non-porous polyurethane such that both sound absorption and sound attenuation characteristics of the dashboard insulator 80 are enhanced.

Referring now to FIG. 14, operations for producing a carpet assembly 50 (FIGS. 10-12) for use in vehicles, according to embodiments of the present invention, are illustrated. The acoustic properties of a vehicle within which a carpet assembly is to be utilized are ascertained. (Block 3000). A substrate having opposite first and second surfaces is provided, wherein the substrate first surface is configured to be attached to a vehicle panel in contacting face-to-face relationship therewith (Block 3010). A layer of uncured, breathable polyurethane is applied onto the substrate second surface (Block 3020). A porous carpet layer is attached to the substrate such that the carpet layer backing is in contacting face-to-face relationship with the breathable polyurethane layer (Block 3030). The carpet layer and substrate are then formed into a desired shape (Block 3040). The breathable polyurethane layer is then subjected to conditions sufficient to cure breathable polyurethane layer such that the substrate and carpet layer are bonded together to form a porous, breathable carpet assembly having the desired shape (Block 3050). For example, heat and/or other energy forms (e.g., microwave energy) may be applied to cure the polyurethane layer.

Breathable polyurethane may be applied onto the substrate second surface in one or more areas to enhance sound absorption characteristics of the carpet assembly (Block 3060). Alternatively, or in addition to, non-porous polyurethane may be applied onto the substrate second surface in one or more areas to enhance sound attenuation characteristics of the carpet assembly (Block 3070).

Sound attenuating laminates and sound absorbing laminates according to the various embodiments of the present invention facilitate acoustical “tuning” wherein acoustical “hot spots” can be identified and additional material (i.e., non-porous polyurethane to provide a barrier to sound, and/or breathable polyurethane to absorb sound) can be added to attenuate sound. Sound attenuating laminates according to embodiments of the present invention can be “tuned” to provide desired sound attenuating characteristics in selected vehicle locations, such as floor panels, firewalls, door panels, wheel wells, trunk compartment panels, etc. The term “tuned” means that portions of a sound attenuating and/or absorbing laminate can be formed to have a specific acoustic impedance designed to attenuate sound in one or more frequencies or frequency bands, and/or to have a specific absorption characteristic designed to absorb sound in one or more frequencies or frequency bands. Moreover, sound attenuating/absorption laminates according to embodiments of the present invention may have reduced overall weight compared with conventional sound proofing materials, and without sacrificing sound attenuation properties.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1-91. (canceled)

92. A method of producing a sound absorbing laminate for use in vehicles, comprising:
providing a substrate having opposite first and second surfaces, wherein the substrate first surface is configured to be attached to a vehicle panel in contacting face-to-face relationship therewith, and wherein the substrate has elastic memory such that the substrate is unable to maintain an unassisted non-flat configuration;
applying a layer of uncured, breathable polyurethane onto the substrate second surface such that the substrate becomes moldable;
attaching a porous upholstery layer to the substrate, wherein the upholstery layer comprises a backing, and wherein the backing is in contacting face-to-face relationship with the breathable polyurethane layer;
forming the upholstery layer and substrate into a desired shape; and
subjecting the breathable polyurethane layer to conditions sufficient to cure breathable polyurethane layer such that the substrate and upholstery layer are bonded together to form a porous, breathable sound absorbing laminate having the desired shape.

93. The method of claim 92, wherein applying a layer of uncured, breathable polyurethane onto the substrate second surface comprises spraying uncured, breathable polyurethane onto the substrate second surface.

94. The method of claim 92, wherein the substrate comprises thermoformable fibrous material selected from the group consisting of natural fibers, man-made fibers, and blends of natural fiber and man-made fibers.

95. The method of claim 92, further comprising applying additional breathable polyurethane on one or more selected portions of the substrate first surface to enhance sound absorption characteristics of the sound absorbing laminate.

96. The method of claim 92, further comprising applying polyurethane on one or more selected portions of the substrate first surface, wherein the polyurethane is non-porous and is configured to enhance sound attenuation characteristics of the sound absorbing laminate.

97. A porous, breathable sound absorbing laminate for use in vehicles, comprising:
a substrate having opposite first and second surfaces, wherein the substrate first surface is configured to be attached to a vehicle panel in contacting face-to-face relationship therewith, and wherein the substrate has elastic memory such that the substrate is unable to maintain an unassisted non-flat configuration; and
a porous upholstery layer adhesively secured to the substrate via a breathable polyurethane layer, wherein the upholstery layer comprises a backing, and wherein the backing is in contacting face-to-face relationship with the breathable polyurethane layer.

98. The porous, breathable sound absorbing laminate of claim 97, wherein the substrate comprises thermoformable fibrous material selected from the group consisting of natural fibers, man-made fibers, and blends of natural fiber and man-made fibers.

99. The porous, breathable sound absorbing laminate of claim 97, further comprising additional breathable polyurethane on one or more selected portions of the substrate first surface, wherein the additional breathable polyurethane enhances sound absorption characteristics of the sound absorbing laminate.

100. The porous, breathable sound absorbing laminate of claim 97, further comprising additional polyurethane on one or more selected portions of the substrate first surface, wherein the additional polyurethane is non-porous and is configured to enhance sound attenuation characteristics of the sound absorbing laminate.

101. The porous, breathable sound absorbing laminate of claim 97, wherein the substrate first surface has one or more recessed portions formed therein, and further comprising polyurethane applied within the one or more recessed portions.

102-106. (canceled)

107. The method of claim 92, wherein the porous upholstery layer is a carpet layer.

108. The porous, breathable sound absorbing laminate of claim 97, wherein the porous upholstery layer is a carpet layer.

109. The vehicle of claim 102, wherein the vehicle panel is a floor panel, and wherein the porous upholstery layer is a carpet layer.

110. An acoustically tuned laminate configured to be attached to a vehicle panel, comprising:
a substrate having a shape of the vehicle panel, wherein the substrate is configured to be attached to the vehicle panel in contacting face-to-face relationship therewith; and
non-porous polyurethane attached to one or more locations of the substrate, wherein the non-porous polyurethane is configured to attenuate sound passing through the substrate such that the laminate has a selected acoustic impedance configured to attenuate sound in one or more frequencies.

111. The acoustically tuned laminate of claim 110, further comprising breathable polyurethane attached to one or more locations of the substrate, wherein the breathable polyurethane is configured to absorb sound passing through the substrate such that the laminate has a selected acoustic absorption characteristic in one or more frequencies.

112. The acoustically tuned laminate of claim 1 10, wherein the substrate comprises opposite first and second surfaces, wherein the first surface is configured to be attached to the vehicle panel in contacting face-to-face relationship therewith, and wherein the non-porous polyurethane is attached to one or more locations of the first and second surfaces.

113. The acoustically tuned laminate of claim 110, wherein the substrate comprises opposite first and second surfaces, wherein the first surface is configured to be attached to the vehicle panel in contacting face-to-face relationship therewith, and wherein the breathable polyurethane is attached to one or more locations of the first and second surfaces

114. The acoustically tuned laminate of claim 110, wherein the substrate comprises thermoformable fibrous material.

115. The acoustically tuned laminate of claim 110, wherein the non-porous polyurethane comprises a filler selected from the group consisting of calcium carbonate, calcium hydroxide, aluminum trihydrate, talc, bentonite, barytes, silica, clay and mica.

116. The acoustically tuned laminate of claim 110, wherein the substrate first surface has one or more recessed portions formed therein, and wherein the non-porous polyurethane is applied in the one or more recessed portions.

117. The acoustically tuned laminate of claim 111, wherein the substrate first surface has one or more recessed portions formed therein, and wherein the breathable polyurethane is applied in the one or more recessed portions.

118. An acoustically tuned laminate configured to be attached to a vehicle panel, comprising:
a substrate having a shape of the vehicle panel, wherein the substrate is configured to be attached to the vehicle panel in contacting face-to-face relationship therewith; and
breathable polyurethane attached to one or more locations of the substrate, wherein the breathable polyurethane is configured to absorb sound passing through the substrate such that the laminate has a selected acoustic absorption characteristic in one or more frequencies.

119. The acoustically tuned laminate of claim 118, wherein the substrate comprises opposite first and second surfaces, wherein the first surface is configured to be attached to the vehicle panel in contacting face-to-face relationship therewith, and wherein the breathable polyurethane is attached to one or more locations of the first and second surfaces.

120. The acoustically tuned laminate of claim 118, wherein the substrate comprises thermoformable fibrous material.

121. The acoustically tuned laminate of claim 118, wherein the substrate first surface has one or more recessed portions formed therein, and wherein the breathable polyurethane is applied in the one or more recessed portions.
